(19) United States
(12) Patent Application Publication
(10) Pub. No.: US 2022/0408926 A1
(43) Pub. Date: Dec. 29, 2022

(54) Head Support System

(71) Applicants: Pamela Foster, Tuscaloosa, AL (US); Kinsley Varner, Tuscaloosa, AL (US); Kristi Rawlings, Tuscaloosa, AL (US); Brandon Hay, Tuscaloosa, AL (US); Nicholas Petty, Tuscaloosa, AL (US)

(72) Inventors: Pamela Foster, Tuscaloosa, AL (US); Kinsley Varner, Tuscaloosa, AL (US); Kristi Rawlings, Tuscaloosa, AL (US); Brandon Hay, Tuscaloosa, AL (US); Nicholas Petty, Tuscaloosa, AL (US)

(21) Appl. No.: 17/775,880

(22) PCT Filed: Nov. 11, 2020
(86) PCT No.: PCT/US20/60046

§ 371 Date: May 10, 2022

Related U.S. Application Data
(60) Provisional application No. 62/933,631, filed on Nov. 11, 2019.

(51) Int. Cl. A47C 1/10; A47C 1/11; A45D 44/10; A45D 20/00

(52) U.S. Cl. CPC A47C 1/10; A47C 1/11; A45D 44/10; A45D 20/00

(57) ABSTRACT

A head support system is disclosed herein. In various exemplary embodiments, the head support system includes at least one base, a connector, and a support structure. The head support system is configured to comfortably support a user's head and neck in the upright seated position while under a stationary salon dryer. The head support can be adapted to fit standard salon hooded hair dryers, allowing users to comfortably relax while their hair dries.

### CROSS REFERENCE TO RELATED APPLICATIONS

This application claims the benefit of U.S. Provisional Application No. 62/933,631, filed Nov. 11, 2019. The entire contents of the above-identified application are hereby fully incorporated herein by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### Field of the Invention

The present inventive concept relates to the field of head support systems. More particularly, the concept relates to an improved head support system for keeping a user's head upright while using hair dryer chair or using any medical device for which head support can be appropriate.

### Technology in the Field of the Invention

Salon services can range from a simple haircut, completed in about 20 minutes, to a full hair color change, shampoo, blow dry, and a cut, which can last for several hours in a single salon visit. An especially lengthy stage in this process includes the time required for hair to dry or to absorb dyes while positioned under a hair dryer. This process is particularly tedious for the client, who must remain in an upright, seated position for extended periods of time, all while ensuring that his or head is centered within the bowl of the dryer for optimum results. If the client fails to maintain the correct posture and location, their hair dries unevenly, which can potentially ruin the client's hairstyle or color. In certain circumstances, the only remedy for these adverse effects is to repeat the entire process, wasting valuable time for the salon, salon personnel, and the client.

### BRIEF SUMMARY OF THE INVENTION

A head support system is disclosed herein. In one embodiment, the head support system comprises a first base, a connector, and a support structure. The head support system can further include a cushion.

In embodiments, the connector comprises an “S” shape. In alternative embodiments, the connector comprises two triangular faces.

The head support system can further comprise a second base. In embodiments, the second base can be stackable with the first base to increase the height of the support system.

The head support system can be configured to support a user's head without interfering with the user's hairstyle. In embodiments, the head support system is portable. The head support system can weigh less than 20 pounds.

In certain embodiments, the height of the head support system is adjustable. The head support system can be configured to support the heads of individuals with heights between the 5^{th} percentile of females and the 95^{th} percentile of males, inclusive. In one embodiment, the head support system is configured to support the heads of individuals with heights between about 5 feet and about 6 feet, 6 inches. The head support system can be configured to support at least 12 pounds.

In various embodiments, the head support system is resistant to deformation at high heat. The head support system can be configured to provide support to a user in temperatures up to about 180° F. In certain embodiments, the head support system comprises material that is resistant to deterioration by hydrogen peroxide, ammonia, an aniline derivative, or a combination thereof.

The head support system can be configured to avoid placement of a downward force on the air duct, dryer bowl, or a combination thereof. In embodiments, the head support system is configured to fit commonly used professional stationary salon dryers.

The head support system can comprise ABS plastic, Silicone, or a combination thereof.

An alternate aspect includes a method of supporting a user's head. In embodiments, the method comprises attaching the head support system as described herein to a hair dryer and instructing a user to rest their head on the support system while the user's hair is dried.

### BRIEF DESCRIPTION OF THE DRAWINGS

So that the manner in which the present inventions can be better understood, certain illustrations, photographs, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 represents a front, top perspective view of a head support system in accordance with an embodiment of the present invention.

FIG. 2 provides a front, top perspective, exploded view of the connector and support structure, under the FIG. 1 embodiment

FIG. 3 shows a rear, top perspective view of the connecter of FIG. 2.

FIG. 4 provides a front top perspective view of a first base, under the FIG. 1 embodiment.

FIG. 5 shows a front, top perspective view of a second base in accordance with one embodiment of the present invention.

FIG. 6 represents a front, top perspective view of the first base of FIG. 4 in place on a standard salon hair dryer.

FIG. 7 shows a front, top perspective view of the hair dryer and the first base of FIG. 6 with a second base stacked upon the first base.

FIG. 8 provides a photographic rear view of a first base under one embodiment. A set of securing buckles are shown extending across the back of the first base.

FIG. 9 shows a front photographic view of a partially deconstructed head support system under one embodiment.

FIG. 10 shows a front, top perspective view of the FIG. 9 head support system installed on a standard salon hair dryer under one exemplary embodiment.

FIG. 11 shows a side perspective view of the FIG. 10 embodiment.

FIG. 12 provides a photographic side view of the FIG. 10 embodiment in use.

FIG. 13A is a top schematic view of a connector under one embodiment.

FIG. 13B is a side schematic view of the FIG. 13A connector.

FIG. 13C is a front schematic view of the FIG. 13A connector.

FIG. 13D is a back schematic view of the FIG. 13A connector.

FIG. 14A is a top, front perspective schematic view of a first base under one embodiment.

FIG. 14B provides a front schematic view of the FIG. 14A first base.

FIG. 14C shows a top schematic view of the first base of FIG. 14A.

FIG. 14D is a side view of the first base of FIG. 14A.

FIG. 15A shows a top, front perspective schematic view of a second base under one embodiment.

FIG. 15B is a front schematic view of the FIG. 15A second base.

FIG. 15C provides a top schematic view of the second base of FIG. 15A.

FIG. 15D shows a side schematic view of the second base of FIG. 15A.

FIG. 16A provides a bottom schematic view of a support structure under one embodiment.

FIG. 16B shows a front schematic view of the FIG. 16A support structure.

FIG. 16C is a top side schematic view of the FIG. 16A support structure.

FIG. 16D is a side schematic view of the FIG. 16A support structure.

FIG. 17 provides a head support system under an alternate embodiment.

FIG. 18A provides a graphical representation of survey results obtained from users during experimental use of the head support system.

FIG. 18B provides a graphical representation of survey results obtained from salon personnel during experimental use of the head support system.

FIG. 19A provides a photographic view of a strength test of one embodiment of the present invention.

FIG. 19B shows a photographic view of a fractured base of the FIG. 19A embodiment following the strength test.

FIG. 20 shows a graphical representation of constraints and displacement collected using Finite Element Analysis (FEA).

FIG. 21 shows a graphical representation of von-Mises stress data collected using FEA.

FIG. 22A shows a side perspective, exploded view of a head support system in yet another embodiment.

FIG. 22B shows a front view of the FIG. 22A head support system.

### DETAILED DESCRIPTION OF CERTAIN EMBODIMENTS

Detailed descriptions of one or more preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in any appropriate manner.

### Definitions

The singular forms “a,” “an,” and “the” include plural reference unless the context clearly dictates otherwise. The use of the word “a” or “an” when used in conjunction with the term “comprising” in the claims and/or the specification may mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly “an example,” “exemplary” and the like are understood to be non-limiting.

The term “substantially” allows for deviations from the descriptor that do not negatively impact the intended purpose. Descriptive terms are understood to be modified by the term “substantially” even if the word “substantially” is not explicitly recited. Therefore, for example, the phrase “wherein the lever extends vertically” means “wherein the lever extends substantially vertically” so long as a precise vertical arrangement is not necessary for the lever to perform its function.

The terms “comprising” and “including” and “having” and “involving” (and similarly “comprises,” “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

As used herein the term “about” is used to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The words “user,” “client,” and “customer” can be used interchangeably to refer to any individual receiving salon services or hair-care services.

### DESCRIPTION OF SELECTED SPECIFIC EMBODIMENTS

Current hooded hair dryers do not provide support for the user's neck which can result in improper hair drying, sub-optimal style, inferior color results, and leads to neck discomfort. The presently disclosed head support system is designed to remedy these as well as many other issues associated with current hooded hair dryers and can provide a comfortable headrest that aids in keeping the user's head in a stationary position.

A head support system 100, 900, 1100 is disclosed herein. In various exemplary embodiments, the head support system 100, 900, 1100 is configured to comfortably support a user's head and neck in the upright seated position while under a stationary salon dryer. The head support 100, 900, 1100 can be adapted to fit standard salon hooded hair dryers, allowing users to comfortably relax while their hair dries. The head support system can be configured to ensure even drying of the user's hair. In embodiments, the presently disclosed head support system improves a client's experience by adding a level of comfort and can save the client, salon, and stylist valuable time by preventing the need to repeat the process due to uneven drying.

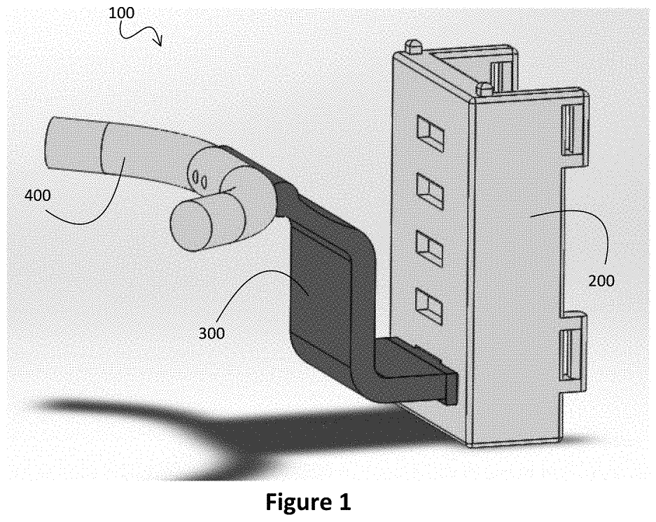

FIG. 1 provides a schematic front and top perspective view of a head support system 100 under one embodiment. The head support system 100 comprises at least one base 200, a connector 300, a support structure 400, a cushion (seen more clearly at 500 of FIG. 9), or a combination thereof.

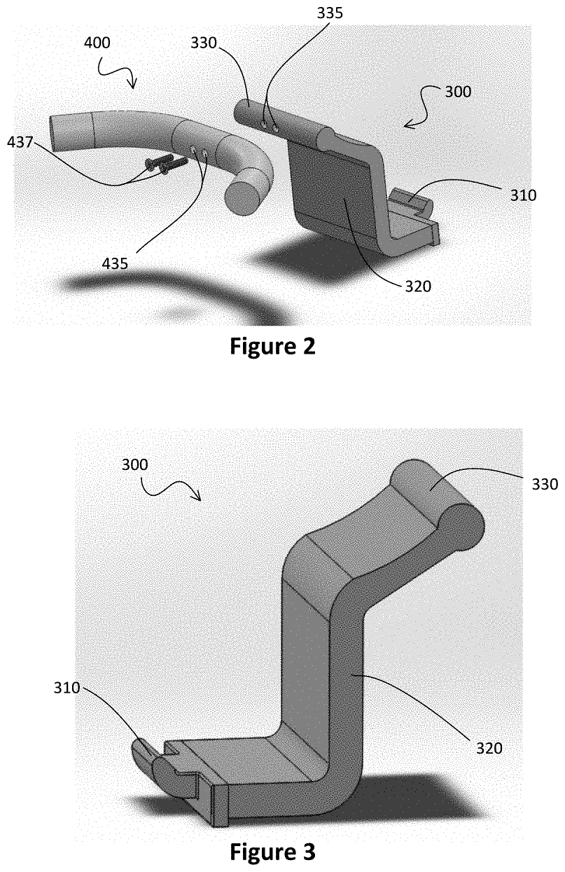

FIG. 2 shows a front and top perspective view of a support structure 400 adjacent to a connection portion 330 of a connector 300, under one embodiment. The support structure 400 is shown exploded away from the connector 300, with two screws 437, which serve as a means for attaching the support structure 400 with the connector 300. In the FIG. 2 embodiment, the screws 437 are aligned with support structure through-openings 435 and reciprocal connector through-openings 335. In embodiments, the support structure through-openings 435, connector through-openings 335, or both are configured to threadably receive the screws 437. Although the FIG. 2 embodiment pictures screws 437 as a means for attachment, alternate embodiments comprise any means of attachment known to one of skill in the art. Exemplary means for attachment of the connector 300 and support structure 400 include, snapping mechanisms, glue, nails, hook and loop connections, frictional attachment mechanisms, or a combination thereof. In certain embodiments, the support structure 400 is integral with the connector 300.

FIG. 3 provides a rear, side perspective view of a connector 300 under one embodiment. In various exemplary embodiments, the connector 300 comprises a connection portion 330, a body 320, a locking tab 310, or a combination thereof. As shown in FIG. 3, the connector 300 can comprise a generally S-shaped body 320 with the locking tab 310 projecting to the rear and a connection portion 330 projecting to the front.

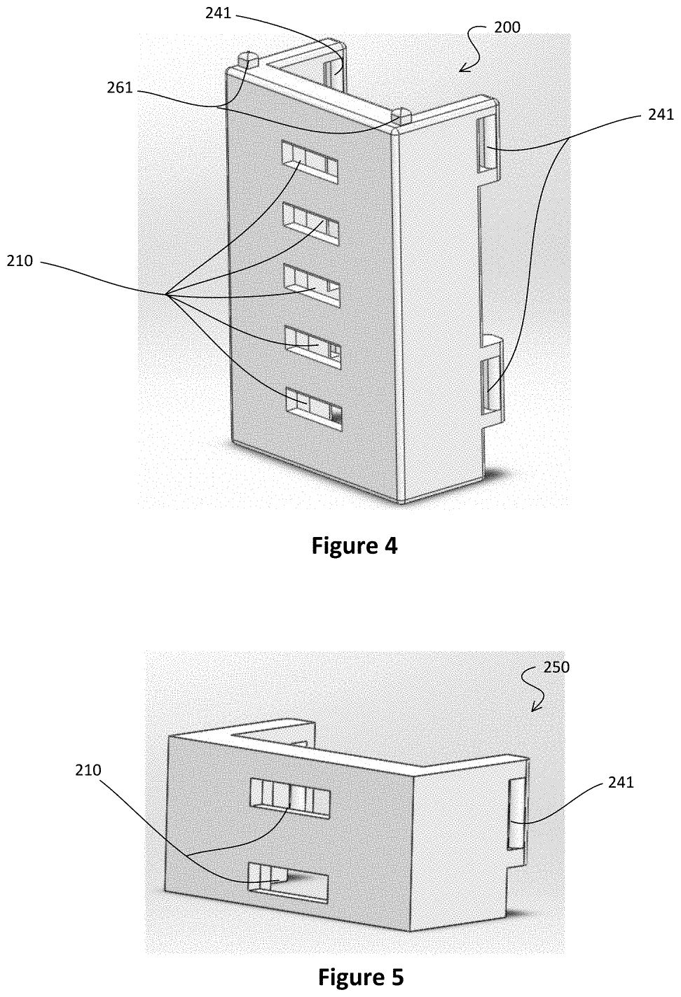

FIG. 4 shows a top, front, perspective view of a base 200 under an embodiment of the present invention. As shown, the base 200 can comprise at least one slot, notch, gap, or hole that can serve as a locking tab receiver 210. In embodiments, the base 200 comprises a plurality of locking tab receivers 210. The base 200 can comprise two or more locking tab receivers 210. In certain embodiments, the base 200 comprises up to 10 locking tab receivers. The base 200 can comprise one, two, three, four, five, six, seven, eight, nine, or ten locking tab receivers 210. The base 200 can comprise a a hole, gap, or notch 241 which can be used in attaching and securing the base 200 to a hair dryer. In embodiments, the base is configured to be reversibly attached to a hair dryer. In alternate embodiments, the base 200 can be integral with a hair dryer. The base 200 can further comprise a mechanism for stacking a second base thereon. In the FIG. 4 embodiment, a pair of stacking protrusions 261 can be seen extending from the top surface of the base 200. In embodiments, a second base can comprise a pair of indentations configured to receive the protrusions 261 of the first base 200, which can provide a means of reversibly securing the second base on the first base 200. Either base can comprise any number of stacking protrusions 261 that would be commercially reasonable. In embodiments, the base 200 comprises a single stacking protrusion 261. The base 200 can comprise up to 20 stacking protrusions 261. In embodiments, the base comprises one, two, three, four, five, six, seven, eight, nine, or ten stacking protrusions 261. Although stacking protrusions are shown in the FIG. 4 embodiment, alternate mechanisms for staking a second base are known to those of skill in the art and, as such, as fully incorporated into the present disclosure.

FIG. 5 provides a top, front perspective view of a second base 250 in an embodiment of the present invention. In embodiments, the second base 250 can be stacked upon a first base. In alternate embodiments, the second base 250 can serve as the only base or the first base can be stacked upon the second base 250. The FIG. 5 second base 250 is shown with two locking tab receivers 210, but it is understood that the base can comprise any number of locking tab receivers that are commercially feasible. In embodiments, the second base 250 comprises a plurality of locking tab receivers 210. The second base 250 can comprise two or more locking tab receivers 210. In certain embodiments, the second base 250 comprises up to 10 locking tab receivers. The second base 250 can comprise one, two, three, four, five, six, seven, eight, nine, or ten locking tab receivers 210. Although the second base 250 is shown without stacking protrusions, alternate embodiments can comprise stacking protrusions 261, or are otherwise configured for stacking as discussed above.

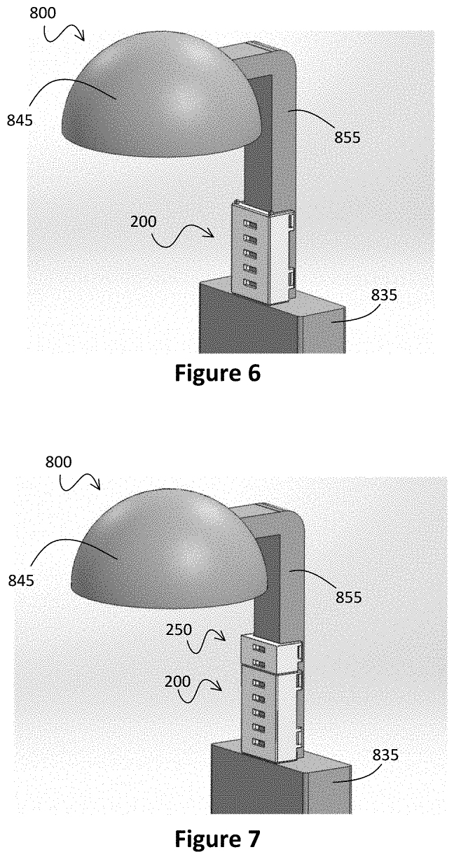

FIG. 6 shows a base 200 positioned for attachment to a hair dryer 800 under one embodiment. The base 200 can be seen resting gravitationally upon a housing 835 of the dryer, and the sides of the base 200 are shown extending at least partially around the sides of the drying duct 855 of the hair dryer 800. The bowl 845 of the dryer 800 is shown in a drying position. In operation, the base 200 of the support system 100 can be reversibly attached to the drying duct 855 of the hair dryer via an attachment means.

FIG. 7 provides an exemplary stackable embodiment of the presently disclosed support system 100 wherein a first base 200 is shown resting gravitationally upon the housing 835 of the dryer, and a second base 250 can be seen resting gravitationally on top surface of the first base 200. The sides of both the first and second bases 200, 250 are shown extending at least partially around the sides of the drying duct 855 of the hair dryer 800. As discussed above, in operation the first and second bases 250 can be reversibly attached to the dry duct 855 via an attachment means. In alternate embodiments, the first base 200, second base 250, or both are integral with at least one component of the hair dryer 800. The first base 200, second base 250, or both can be integral with the dryer duct 855, the dryer housing 835, or the dryer bowl 845. In various exemplary embodiments, the head support system 100 is configured to fit the constraints of commonly used professional stationary salon dryers. Exemplary salon dryers include stationary salon dryers. Examples of a commonly used salon dryers include those manufactured, produced, or marketed by Belvedere™ Belvedere, Ill.), the Gemini® (Gemini USA, Inc., Chicago, Ill.), and the Venus™ (Highland, Highland, Ill.). Most standard professional stationary salon dryers comprise three main components: a drying duct, a housing of the dryer, and a bowl. The head support system 100 can be configured to fit any one or more of the drying ducts 855, the housing 835, or the bowl 845. In embodiments, the head support system is designed to not interfere with the components of the dryer.

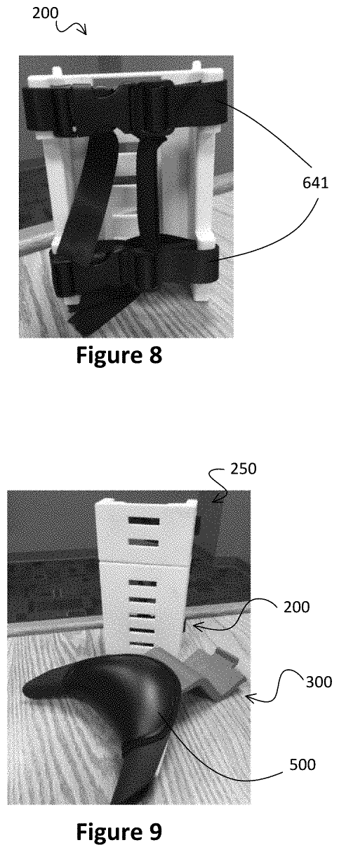

As shown in FIG. 8, the attachment means can comprise at least one strap 641 that extends across the back of the base 200. The strap 641 can be connected to a hole, gap, or notch (seen at 241 of FIG. 4) of the base 200. Embodiments can comprise more than one strap 641. The base 200 can comprise one, two, three, four, five, six, seven, eight, nine, or ten straps 641. In embodiments, one or more of the straps 641 comprise a tensioning mechanism configured to tightly secure the base 200 to a hair dryer. In certain embodiments, the strap 641 comprises a ratchet, a drawstring, or an alternative tensioning mechanism. The strap 641 can include a buckle, VELCRO® brand-style hook and loop fasteners, snaps, buttons, at least one zipper, tape, glue, or a combination thereof for securing the strap 641 to a dryer. Alternative attachment means include, but are not limited to, a clam-shell style attachment comprising at least one hinge-point that permits the base to be affixed around a hair dryer, a clamping mechanism, one or more clips, one or more screws, one or more nails, frictional attachment means, any other means known in the art, or a combination thereof.

FIG. 9 provides a photographic view of a partially deconstructed head support system 100 that comprises a first base 200, a second base 250, a connector 300, a support structure 400, and a cushion 500. The connector 300, support structure 400, and cushion 500 are shown connected to one another and lying adjacent to the first and second bases 200, 250. In this embodiment, the support structure 400 is not visible because the cushion 500 is shown surrounding the support structure 400.

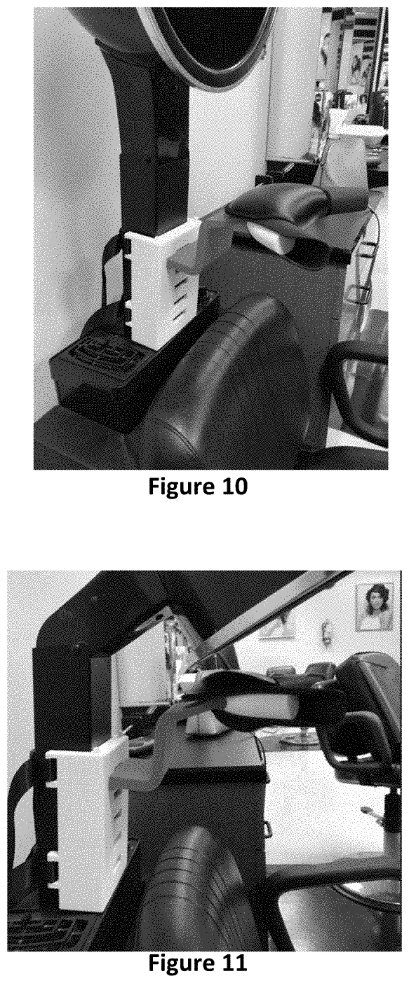

FIG. 10 shows a photographic view of the exemplary embodiment of FIG. 9 as assembled and installed on a hair dryer with only the first base 200. A right corner of the support structure 400 is visible underneath the cushion 500.

FIG. 11 provides a detailed side view of the head support system 100 of FIG. 10. The locking tab 310 of the connecter is disposed within the topmost locking tab receiver 210 of the base, and the right side of the support structure 400 is visible underneath the cushion 500.

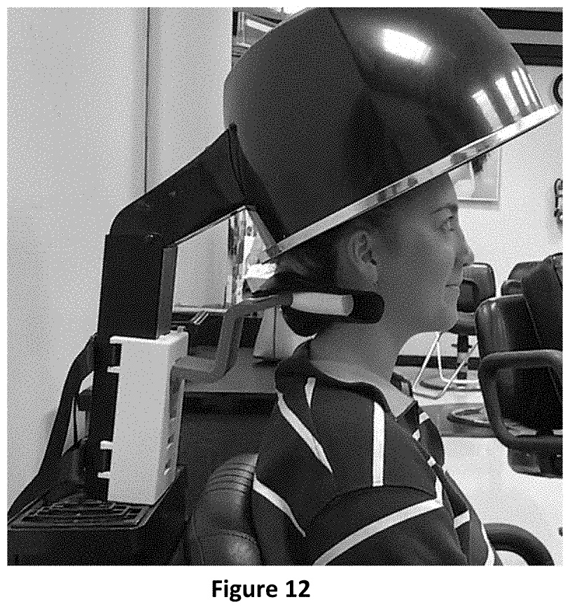

FIG. 12 shows the head support system 100 in operation under one embodiment. The body 320 of the connector 300 extends distally from the base 200 and the dryer 800 such that the support structure 400 is generally located over the back rest of the chair underneath the dryer 800. As can be seen, when so arranged a user of the support system 100 can lean against the support structure 400 such that the bowl 845 of the dryer 800 covers the user's hair to permit even drying. In certain embodiments, the body 320 of the connector 300 can be adjustable in the distal, proximal, or both directions to permit complete centering of a user's head within the bowl 845 of a dryer. An exemplary means of such centering mechanism can include a portion of the connector body 320 that can be telescopically extended and secured in a given position for the duration of the drying event.

In operation, the support structure 400 can be generally aligned to correspond to the cervical areal of a user's spine. In embodiments, the support structure 400 can be aligned anywhere between the nuchal line of a user's skull and C7 of the user's spine. As exemplified in the FIG. 12 embodiment, the support structure 400 can be generally aligned with the atlas (C1) or axis (C2) of the cervical spine. The support structure can be aligned with an area of the user corresponding to C1, C2, C3, C4, C5, C6, C7, or a combination thereof of a user's spine.

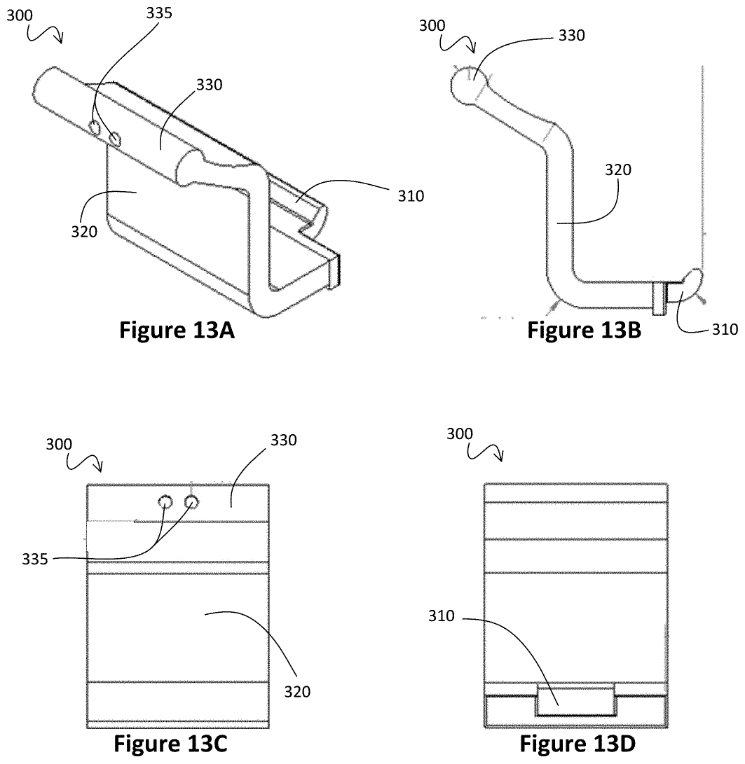

FIGS. 13A-13D provide various schematic views of a connector 300 under one embodiment of the presently disclosed head support system. As shown, the connector 300 comprises a locking tab 310, a body 320, and a connection portion 330. In this particular embodiment, the connection portion 330 comprises connector through-openings 335 configured to receive screws for connection with a support structure 400 (discussed in detail in relation to FIG. 2, above).

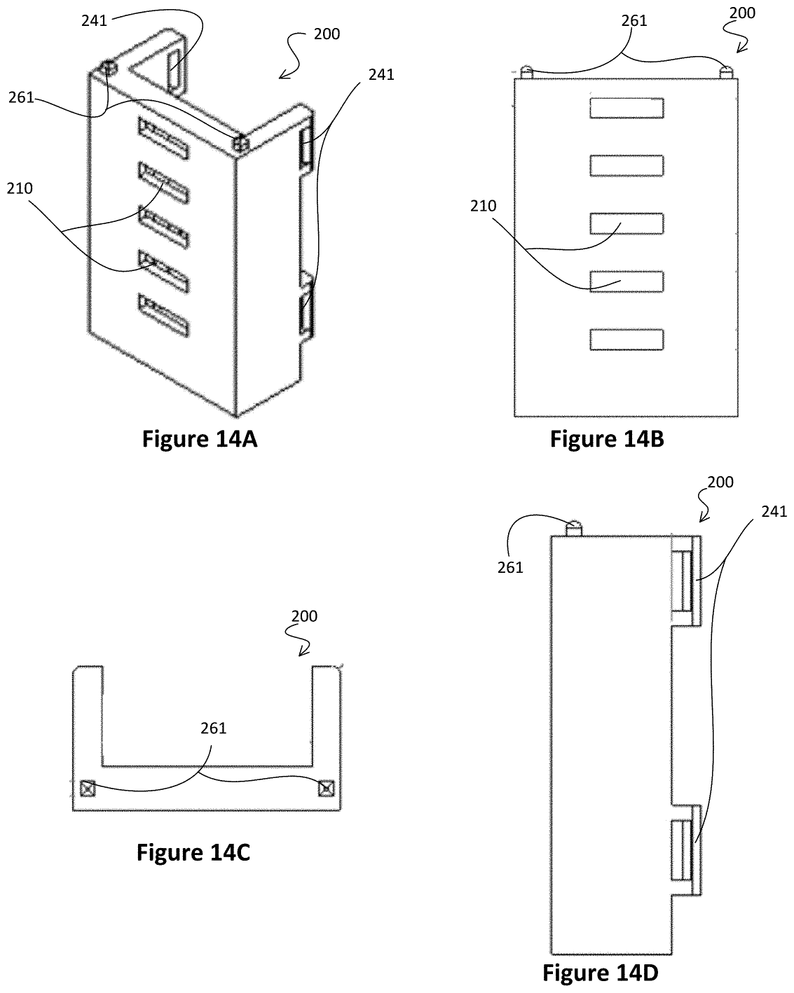

FIGS. 14A-14D provide various schematic views of a base 200 under one embodiment of the presently disclosed head support system.

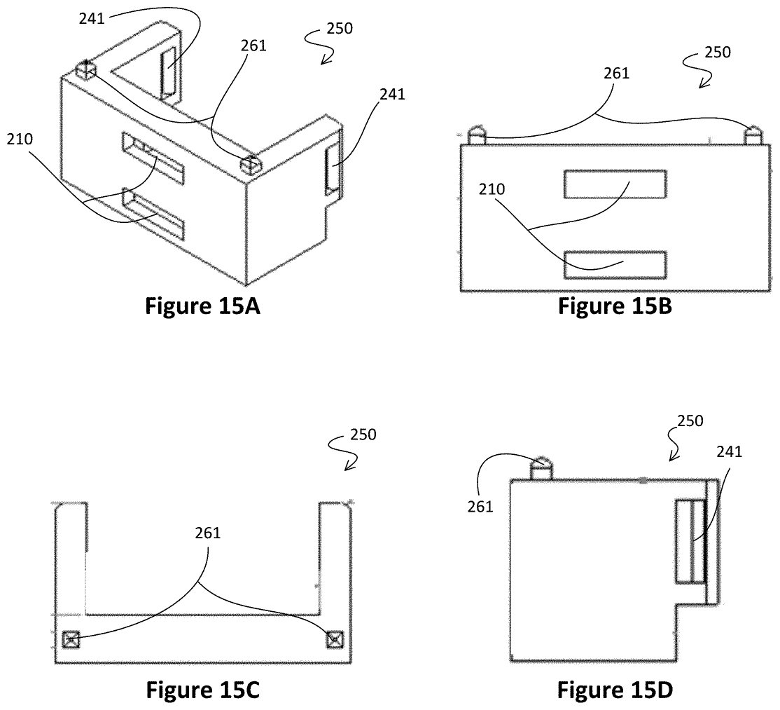

FIGS. 15A-15D provide various schematic views of a second base 250 under one embodiment of the presently disclosed head support system.

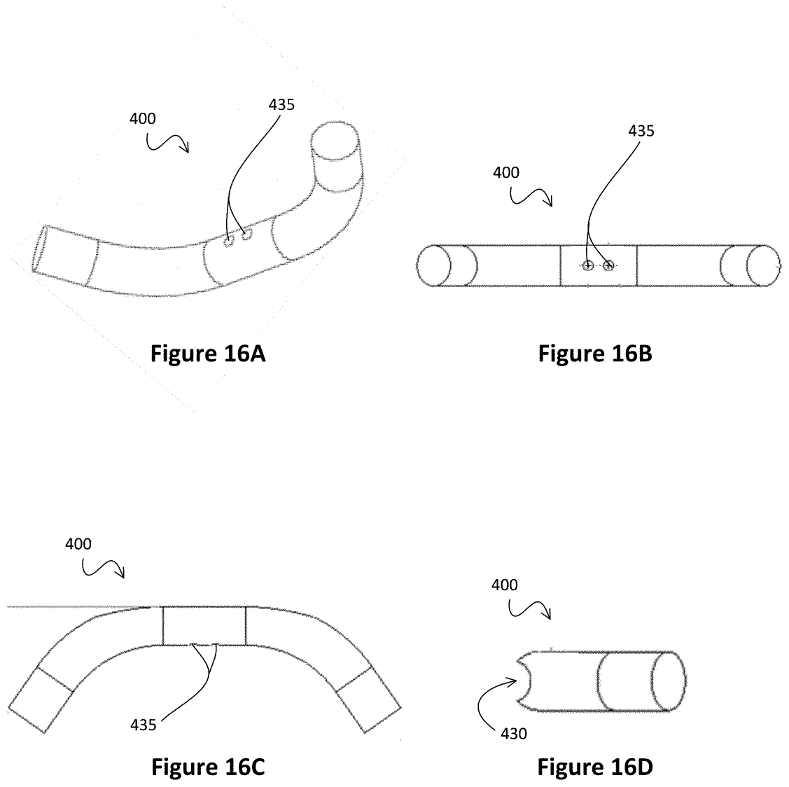

FIGS. 16A-16D provide various schematic views of a support 400 under one embodiment of the presently disclosed head support system. The support structure 400 is shown with a pair of through-openings 435 configured to receive screws for connection of the support structure 400 to the connector 300 (discussed in detail in relation to FIG. 2, above). As shown in FIG. 16D, the support structure 400 can further include a channel, groove, indentation, or cut-away in the back side of the support, which serves a connection alignment portion 430 to assist with aligning the support structure with the connection portion 330 of the connector 300.

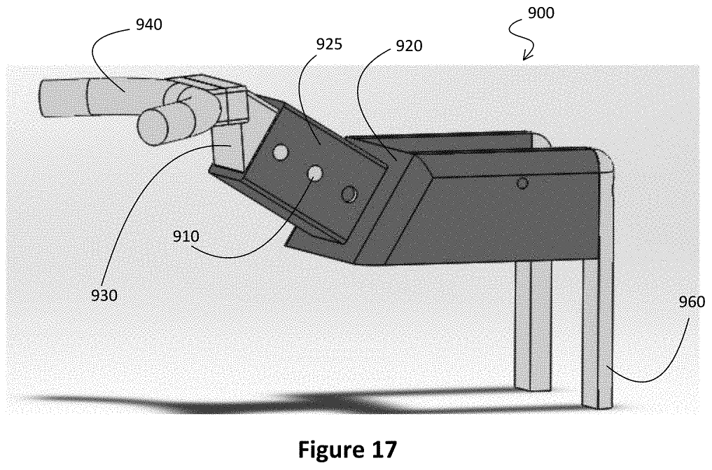

FIG. 17 provides a side perspective view of a head support system 900 in an alternate embodiment. The FIG. 17 embodiment comprises a support structure 940, a connector 930, and a base 920. Any one or more of these components can be reversibly attached to the remaining components. In alternate embodiments, any two or more components are integral with one another. As can be seen, the base 920 comprises a receiving portion 925 that is configured to receive and hold the connector 930. The receiving portion 925 can comprise one or more holes, pass-throughs, channels, or gaps, that serve as locking pin receivers 910 for adjusting the support system 900. In embodiments, the connector 930 comprises at least one hole, pass-through, channel, or gap that is configured to be aligned with any one of the locking pin receivers 910. In such embodiments, the connector 930 can be extended from or retracted into the neck 925 until the at least one hole, pass-through, channel, or gap of the connector alights with a desired locking pin receiver 910 of the receiving portion 925 of the base 920. When properly aligned, the head support system 900 can be reversibly secured into place by passing a locking pin through the locking pin receiver 910 and through the at least one hole, pass-through, channel, or gap of the connector 930. In alternate embodiments, the connector 930 is adjustable via a spring pin that allows the connector 930 to assume at least two positions. In embodiments, the connector 930 can extend in at least three positions The FIG. 17 embodiment is also shown with a pair of legs 960 extending from behind the base 920. In embodiments, the legs 960 can be configured to prevent the head support system 900 from sliding forward on housing of the dryer during use. The legs 960 can be integral with the head support system 900 or reversibly secured thereto. A hole can also be included on the side of the base 920, which can be configured to receive a removable pin that prevents rotational movement of the head support system 900.

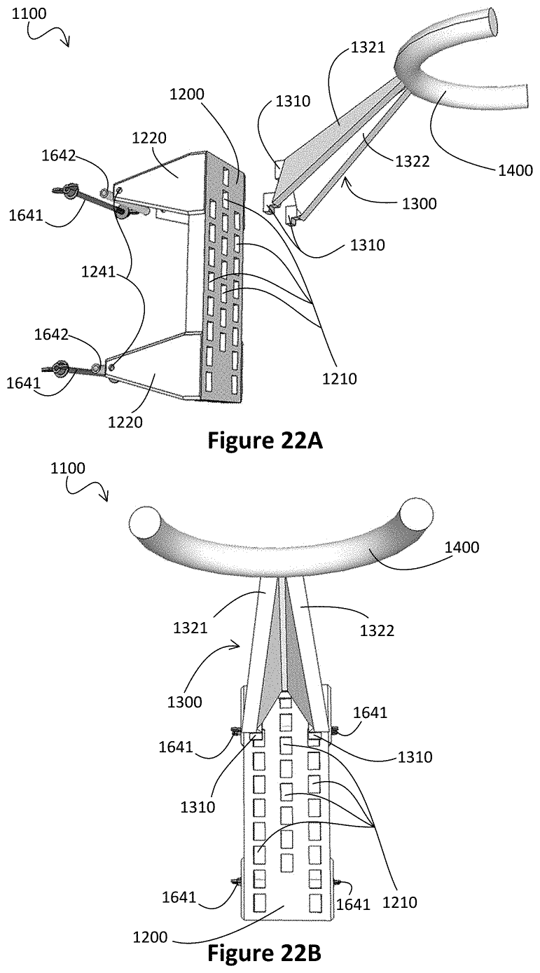

FIG. 22A provides a schematic side perspective view of a head support system 1100 under one embodiment, and FIG. 22B provides a schematic view of the FIG. 22A head support system. As shown in this embodiment, the head support system 1100 comprises at least one base 1200, a connector 1300, a support structure 1400, or a combination thereof. Although not pictured here, the head support system 1100 can also include a cushion (seen more clearly at 500 of FIG. 9) that at least partially surrounds the support structure 1400.

The connector 1300 of the FIG. 22A and FIG. 22B embodiment comprises a body, a plurality of locking tabs 1310, or a combination thereof. In this embodiment, the body of the connector 1300 comprises two a generally triangular plates 1321, 1322 that meet along one leg of each triangular plate 1321, 1322 to form the connector 1300. In alternative embodiments, the connector 1300 comprises a third plate that connects across the hypotenuses of the triangular plates 1321, 1322 to completely enclose the connector 1300. In some embodiments, the connector 1300 comprises a single body with triangular faces. In yet other embodiments, the connecter 1300 comprises a cylindrical body. The connector can comprise a polyhedral body.

As can be seen in the embodiment of FIGS. 22A and 22B, the base of the connector 1300 comprises three locking tabs 1310 that are configured to reversibly attach the connector 1300 to the base 1200. Although three locking tabs 1310 are shown, alternative embodiments can comprise up to ten locking tabs. Certain embodiments can comprise one, two, three, four, five, six, seven, eight, nine, or ten locking tabs.

As shown in FIGS. 22A and 22B, the base 1200 can comprise at least one slot, notch, gap, or hole that can serve as a locking tab receiver 1210. As can be seen, the base pictured in the embodiment of FIGS. 22A and 22B comprises three columns of locking tab receivers 1210, wherein each column corresponds to the location of the locking tabs 1310 on the connector 1300, and each locking tab receiver 1210 is configured to receive a locking tab 1310 of the connector 1300. In this embodiment, each column comprises eight separate locking tab receivers 1210, such that there are a total of 24 locking tab receivers 1210. As such, in operation, the base 1200 of FIGS. 22A and 22B comprises eight different adjustment positions, which permits the height of the support structure 1400 to be adjusted and optimized for the user. Certain embodiments can comprise more than eight adjustment positions. Embodiments can comprise less than eight adjustment positions. Embodiments comprise up to twenty adjustment positions. The base can comprise one, two, three, four, five, six, seven, eight, nine, ten, eleven, twelve, thirteen, fourteen, fifteen, sixteen, seventeen, eighteen, nineteen, or twenty adjustment positions. In embodiments, the base 1200 comprises a plurality of locking tab receivers 1210. The base 1200 can comprise ten or more locking tab receivers 1210. In certain embodiments, the base 1200 comprises up to 50 locking tab receivers. The base 1200 can comprise between 10 and 50 locking tab receivers 1210. In one embodiment, the base 1200 comprises between about 20 and about 30 locking tab receivers 1210.

In embodiments, the base is configured to be reversibly attached to a hair dryer. The base 1200 of FIGS. 22A and 22B comprises a plurality of attachment arms 1220 that are configured to attach and secure the base 1200 to a hair dryer. In operation, the attachment arms 1220 extend at least partially around the sides of the drying duct (seen at 855 of FIGS. 6 & 7) of the hair dryer. The attachment arms 1220 can further comprise a hole, gap, or notch 1241 configured to receive an attachment means 1641. As shown in FIGS. 22A and 22B, the attachment means 1641, 1642 can comprise a threaded rod that can pass through the hole, gap, or notch 1241 and a tubing 1642. The attachment means 1641 can further comprise a wingnut that can be secured on the rod to reversibly secure the attachment means 1641 to the attachment arms 1220 of the base 1200. Thus, when the base 1200 is placed around the dryer duct, the attachment means 1641 can be used to reversibly secure the base 1200 to the dryer. Importantly, although the FIGS. 22A and 22B embodiments picture a threaded rod with wingnuts as a means for attachment 1641, alternate embodiments comprise any means of attachment known to one of skill in the art. Exemplary means for attachment 1641 include a clamping mechanism, one or more clips, one or more snapping mechanisms, glue, nails, hook and loop connections, frictional attachment mechanisms, or a combination thereof. In certain embodiments, the base 1200 is integral with the dryer duct. Alternatively, the attachment means 1641 can comprise at least one strap that can be connected to the hole, gap, or notch 1241 of the base. The base 1200 can further comprise a mechanism for stacking a second base thereon (see FIGS. 7 and 9).

In various exemplary embodiments, the head support system is portable, easy to assemble, adjustable, comprises a sleek and professional look, or a combination thereof. In certain embodiments, the head support system weighs about twenty pounds or less. In embodiments, the head support system weighs between about one pound and about fifteen pounds. The head support system can weigh less than about one pound. In embodiments, the head support system weighs about one, two, three, four, five, six, seven, eight, nine, ten, eleven, twelve, thirteen, fourteen, or fifteen pounds.

In embodiments, the head support system is comprised of few parts that can be readily assembled by a user thereof.

In various exemplary embodiments, the head support system is adjustable. The head support system can be adjustable to accommodate approximately 90% of the population. The head support system can be adjustable to fit individuals that range from heights of the 5^{th} percentile of females to the 95^{th} percentile of males according to any commonly referenced ergonomic standards. In embodiments, the head support system can be adjustable to fit individuals who are at least about 4 feet tall. The head support system can be adjustable to fit individuals up to about 7 feet tall. In embodiments, the head support system fits any individual with a height ranging between about 4′ 6″ tall to about 6′ 6″ tall. The head support system can be adjustable for use with individuals who are between about 5 feet tall and about 6′ 2″ tall.

In embodiments, the support structure extends up to 30 inches from the top of the dryer housing. The support structure can extend up to about 25 inches from the top surface of the dryer housing. In embodiments, the support structure extends up to about 20 inches from the top surface of the dryer housing. The support structure can extend between about 5 inches to about 20 inches from the top of the dryer housing. In certain embodiments, the support structure extends between about 7 inches to about 18 inches from the top surface of the housing of the dryer.

Any of the various head support systems can be configured to support at least the weight of an average adult human head. The head support system can be configured to support the weight of an average human head plus any accessories that are commonly used in the hair care or hair styling industry. Such accessories can include, but are not limited to curlers, foils, hair care products, or any other accessory or product commonly used in the art. The head support system can be configured to support body weight beyond that of an individual's head, hair care accessories, or a combination thereof. In embodiments, the head support system is configured to support at least 5 pounds. In embodiments, the head support system is configured to support up to about 200 pounds. The head support system can be configured to support up to about 100 pounds. The head support system can be configured to support at least about 75 pounds, at least about 50 pounds, or at least about 25 pounds. In certain embodiments, the head support system can support at least 10 pounds. The head support system can be configured to support between about 10 pounds to about 100 pounds. In certain embodiments, the head support system is configured to support at least about 20 pounds. The head support system can be configured to support between about 15 pounds and 100 pounds. In embodiments, the head support system is capable of supporting between about 20 pounds and about 75 pounds.

In embodiments, the head support system is resistant to deformation at high temperatures. The head support system can be resistant to deformation at the maximum temperature capable of being produced by a professional stationary hair dryer. In embodiments, the head support system will not deform at temperatures up to about 300° F. The head support system can be resistant to deformation at temperatures up to about 200° F. In certain embodiments, the head support system will not deform at temperatures up to about 180° F. The head support system can remain structurally stable at temperatures up to about 160° F.

The head support system can also be resistant to damage or degradation following prolonged daily exposure to chemicals commonly used in hair salon at concentrations commonly used in hair salons. These materials include, but are not limited to hydrogen peroxide, ammonia, aniline derivatives, or combinations thereof. The head support system can be comprised of any materials known in the art to be suitable for 3D printing, sculpting, injection molding, casting, or other known methods. The head support system can comprise a material that is high energy-absorbent. In certain embodiments, the head support system is comprised of materials that are easy to clean. The head support system can comprise an easy-to-clean surface. In embodiments, the head support system is comprised of ABS plastic, Silicone, or a combination thereof.

In embodiments, the head support system is configured to avoid application of downward force on the air duct, the dryer bowl, or a combination thereof.

The head support system can be configured to avoid interference with the functioning of the hair dryer. In embodiments, the head support system does not block air blowing out of the dryer bowl. Embodiments of the head support system do not interfere with or otherwise disrupt the user's hair style while in use by the user.

In embodiments, the support structure of the head support system comprises a width that is sufficient from preventing a user's head from sliding. In certain embodiments, the width of the support structure is at least 7 inches.

In certain embodiments, the area of the support structure that contacts the neck is comprised of energy-absorbent material. The area of support structure that contacts the neck can comprise a vertical contour that is adapted to improve comfort of the user when assuming a normal sitting posture. At least a portion of the support structure can be padded. In embodiments, the support structure comprises a soft upholstery. The support structure can comprise a cover. In embodiments, the cover comprises a cushion. In embodiments, the cover is detachable. The cover can be configured to be readily removed from the support structure. In embodiments, the cover is reversibly secured to the head support by any means known in the art. By way of example, the cover can be secured to the support structure via a buckle, VELCRO® brand-style hook and loop fasteners, buttons, at least one zipper, tape, glue, or a combination thereof. In alternate embodiments, the head support system does not include a separate cover. The cover can be integral with or permanently attached to the support structure.

In alternate embodiments, the neck rest is fully integrated into a professional stationary salon dryer. In embodiments, the stationary dryer's drying duct can be replaced with a duct that includes a neck rest built in.

Embodiments can be created through the process of sculpting, injection molding, casting, or other known methods. Certain embodiments may be printed using three-dimensional printing technology.

Although the exemplary embodiments disclosed herein related to head support systems for use with stationary hair dryers, the inventive concept is not so restricted. The head support system is appropriate for any use wherein support of a user's head is desired. The presently disclosed systems and methods can be particularly useful for applications within the medical field. In embodiments, the head support system is used in dentistry, orthodontics, surgical procedures, medical examination procedures, cosmetic procedures, and the like.

Other compositions, compounds, methods, features, and advantages of the present disclosure will be or become apparent to one having ordinary skill in the art upon examination of the following drawings, detailed description, and examples. It is intended that all such additional compositions, compounds, methods, features, and advantages be included within this description, and be within the scope of the present disclosure.

### EXAMPLES

### Example 1

I. Introduction/Background

Making people feel good about the way they look through salon services is key for running a beauty salon business. One key aspect of satisfying people at the salon is the comfortable experience one receives. Frequently, after a customer gets a hair service done, washing and drying the customer's hair is required. At times, customers could spend up to an hour under a hooded hair dryer. Many individuals are known for falling asleep at this time or getting uncomfortable quickly due to the user having to hold their head upright for an extended period of time. The presently disclosed neck support is configured for hooded hair dryers and will allow users to comfortably relax while their hair dries. Current hooded hair dryers do not provide support for the user's neck which results in hair not drying properly and leading to neck discomfort.

The top hair salon franchises, such as Supercuts®, use Belvedere Professional Salon Dryers, so the team was directed to build a prototype that would fit the constraints of professional stationary salon dryers. The working prototype is achieved through extensive research of the dryers, ergonomics, and the client's given standards. The professional stationary salon dryers consist of three main components: the drying duct, the housing of the dryer, and the bowl. The prototype is designed to not interfere with the components of the dryer as well as the dryer's purpose.

The benefits of the neck support, called the Heads Up Device, are that salon customers will enjoy their hair salon experience more with some much-needed added comfort. Also, the salon stylist will save time by not having to go back over the hair. Currently, the hair salon market does not have anything like this device. The hair salon market is a very lucrative industry with the global market estimated around 87.7 billion dollars in 2018 (Trefis.com, 2017). Specifically, Sally Beauty Holdings Inc. sells and distributes to over 5,000 stores, including 175 franchised units, which is where this device could possibly be retailed through (Sally, 2017). Just in the U.S. alone, beauty, cosmetics, and fragrance stores revenue around 22.2 billion dollars last year (Cohen, 2018). Undoubtedly, the hair salon market has huge opportunities for new products, in which the client hopes the Heads Up Device could thrive in.

II. Project Methodology

A salon visit can be a very complex and extensive process for some customers. Salon services can range from a just a simple haircut, completed in 20 minutes, all the way to a full hair color change, shampoo, blow dry, and a cut, lasting hours in one salon visit. One of the longer salon processes is allowing for the hair to dry or soak up hair dyes while under a hair dryer. The tedious part of this process is that the user must remain in an upright seated position while centered under the bowl of the dryer for up to an hour. If the user does not remain in the correct position, the hair dries unevenly causing adverse effects on the hairstyle and results in having to repeat the process. The intended final product function is to comfortably support the user's head and neck in the upright seated position while under a stationary salon dryer.

In order to be marketable to salon owners, the team wanted the design to be portable, easy to assemble, adjustable, and look sleek and professional. To be portable and easy to transfer from dryer to dryer, the maximum weight was constrained to 15 pounds. To reduce packaging and shipping costs of the final product, we assumed the design would need to be in as few parts as possible so that the salon workers could assemble it themselves. For ease of assembly, the product should be packaged as a maximum of two parts with one step for assembly. The design had to be adjustable to reach heights of 5th percentile females and 95th percentile males according to ergonomic standards. To meet these standards, the neck rest should extend between 7-18 inches from the base of the dryer. We wanted our design to look sleek and professional by looking uniform with the dryer, that is, all parts colored black with a smooth or glossy finish.

The main functional requirement of the Heads Up device is that it must support a 12-pound head plus the additional weight of curlers, foils, and products in the user's hair. The device should also support additional body weight as a safety precaution in the incident that someone uses the device incorrectly. The goal of our design was to fit all professional stationary salon dryers. Major constraints faced were that all materials must be resistant to deformation at temperatures up to 160 degrees Fahrenheit which is the maximum heat of the dryer. All materials used also had to be resistant to chemicals used in hair salons, specifically, hydrogen peroxide, ammonia, and aniline derivative. The air duct that extends out of the base of the dryer and holds the dryer bowl up is held up only by friction, so our design could not place any downward force on the air duct or dryer bowl. Finally, the Heads Up product cannot block any air blowing out of the dryer bowl or interfere with the user's hair style.

Customers often have trouble keeping their head in the correct position while getting their hair dried under a hooded salon hair dryer. This causes un-evenly dried hair and may result in an undesired result in their appearance. We designed a comfortable headrest that aids in keeping the user's head in a stationary position. The design, went through many iterations, but a final prototype was completed and approved.

There are several brands of salon hooded hair dryers on the market, such as Belvedere, Gemini, and Venus. Each brand was assessed for their constraints to attempt to design a headrest that would fit each model. The drying duct of each model is held in by friction alone, so no weight could be placed directly on the dryer duct without the risk of it moving. There is 0.5 inches of dryer base in front of the dryer duct and less than 1 inch of dryer base on either side of the dryer duct. The device could also not interfere with the user's hairstyle. Given these constraints, existing headrests and patents were researched, but no product currently exists on the market.

The headrest must be able to fulfill several functional requirements as well. The design needed to withstand temperatures up to 160° F. from the dryer bowl and be resistant to common chemicals found in a hair salon. The device needed to support 12 pounds, the average weight of a human head. Ergonomics of headrests were researched, and the adjustability should meet 5th percentile of women and 95th percentile of men, thus the headrest height range should be between 7-18 inches from the base of the dryer to accommodate for both. The minimum width of a headrest should be 7.784 inches to prevent the head from sliding. The area where the headrest comes in contact with the neck should be highly energy-absorbent and have a vertical contour adapted to the normal sitting posture. The surface should be padded with a soft upholstery to prevent irritation.

We brainstormed three ideas based on the constraints and functional requirements. A prioritization matrix composed of several weighted criterion was used to choose the best design. Support and comfort were the most important qualities of the design. Cost was the next most important because the client wanted the retail price to be under $80. Once the design was selected, the next step was to research materials that would be best for a prototype.

After thorough research, ABS plastic was chosen for the prototype. ABS plastic met the minimum requirements for heat and chemical resistance, and it is strong enough to support the weight of an average human head. ABS plastic was also picked because it would allow the design to be printed at UA's 3D printing lab. Silicone was chosen for the headrest because of its high energy-absorbent properties and its resistance to chemicals. Silicone's high heat resistance and it's easy to clean surface deemed Silicone as an appropriate material selection for the cushion.

Once the design and bill-of-materials were approved, the design was printed, and a silicon cushion was ordered that would easily fit over the cushion support. The first prototype can be seen in FIG. 17. The prototype had two attachable legs on the back to prevent the design from sliding forward on housing of the dryer. The hole seen on the side of the design base was for a removable pin to prevent forward moments that would cause it to rotate. The connector on the prototype was adjustable via a spring pin. The spring pin would allow the connector to extend in three positions.

After the prototype finished printing, the device was taken to an in-home salon and tested. As expected though, the prototype had no issues with the heat produced by the dryer. The maximum heat of the dryer did not exceed the thermal range of ABS plastic or the Silicone cushion, implying the materials were well chosen.

We brainstormed new ideas and revised the prototype. The base of the design was kept similar, but the legs were removed and replaced with nylon straps. Due to limited clearance on the housing of the dryer, a stackable base was developed with five slots on one base. These slots allowed the neck to detach and reach a bigger height adjustability range without interfering with the dryer duct or the seat. A second base could be stacked on the first base to accommodate for the sitting height of 95 percentile men. The new design for the base can be seen in FIG. 4.

Following the revision of the design base, the connector needed a method of sliding into the slots easily. A tab was integrated into the bottom of the connector. The tab comes out at a 45° to allow it to be inserted and removed to not interfere with the dryer duct. An FEA was analyzed on the tab to confirm it could support the necessary weight. The connector shape was revised as well. It was given an “S” shape to come out a distance from the dryer and then rise up for additional height, and finally back out where it connects to the cushion support. This “S” shape also creates space giving the connector clearance, so it does not interfere with the bowl of the dryer. The connector piece can be seen in FIG. 3. When inserted into the slots of the base, the connector had adjustable heights of 6.25″, 7.35″, 8.45″, 9.55″, and 10.65″. When the second base is stacked on the first base, the connector reached additional heights of 11.75″, 12.85″, 13.95″, 15.05″, and 16.15″.

Originally, the cushion support angle was going to be adjustable, but due to input from professionals in the salon industry, the cushion support has a fixed position. This was done so at the point of contact with the neck, it would not interfere with hair accessories. The cushion support's radius was also increased to accommodate as many neck sizes as possible. This increase in radius required a new cushion support to be ordered. The material remained the same because Silicone performed well in thermal testing. The new cushion support did have extra padding for increased comfort. The second prototype can be seen in FIG. 1.

Once the prototype was finished printing, it was tested at the local JCPenney salon. The design fit well on the dryers at JCPenney, but the dryers were not designed for the 95th percentile of men, therefore the second stackable base was causing interference with the dryer bowl. We then cut the second base, so it would fit properly on the dryer duct with no interference. The second stackable base has only two height adjustment options. The stackable base can be seen in FIG. 5.

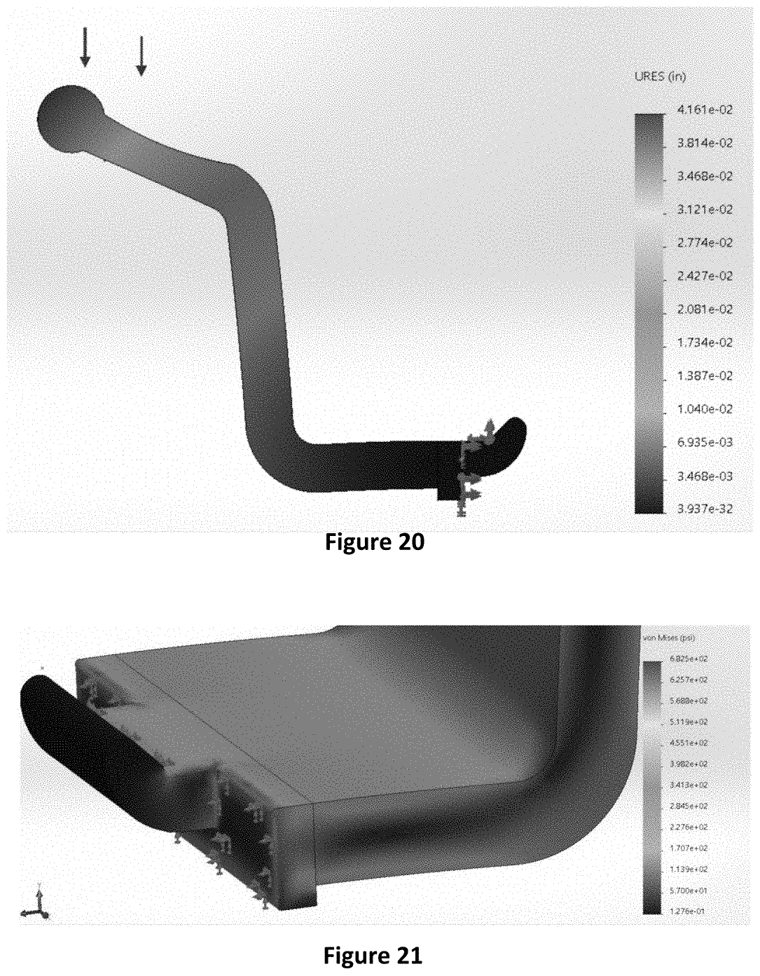

Preliminary testing data was collected using Finite Element Analysis (FEA) on the connector component of the Heads Up device. The tab on the connector was determined to be the weakest feature in the design, as failure at this point would be catastrophic. In FIG. 20, to mimic a worst-case scenario, a 12-pound force was placed on the top end of the connector component, shown by the purple arrows, and the tab was constrained as if it was inserted in the base component of the device.

With the above scenario the maximum deflection was 0.04161 inches and the prominent stresses were displayed at the point where the tab contacts the base. The von-Mises stresses reached a maximum of 682.5 psi in the corners, mainly due to stress concentrations, shown in FIG. 21. The data gathered from the FEA validated the premises of the device and allowed the team to move on to in field testing with the prototype.

In field testing of the prototype was broken down into five main categories: a heat test, a fit and function test, a height validation test, a strength test, and a user feedback test. The heat test was designed to test different points on the device and validate the temperatures seen by the device do not exceed the material selected heat resistance temperatures. During the heat test, the device was assembled on the dryer with the maximum heat setting turned on. A Fluke infrared thermometer scanner is to be used to take the various temperature measurements. The temperature measurements consisted of points on the base, the connector, the cushion, and the buckles. The areas where the temperatures were taken were chosen due to their proximity to the dryer duct or hood. The temperature for the cushion and connector were taken in the areas where the components were exposed to direct heat from under the dryer bowl. The base and buckles contact the dryer duct and receive the greatest amount of heat. After 30 minutes from start up, professional hooded hair dryers reach their maximum temperature, so the team decided to conclude the heat test then,

The fit and function test included various aspects of the device fitting on the dryer. The device was assembled on the dryer and checked for stability, clearance, and appropriate neck client neck alignment. To ensure the connector did not interfere with the normal operation of the dryer, the bowl was lowered into position as if the dryer was in use. The neck height was be checked by user validation. Next, the height requirement test was used to validate if the device satisfies the ergonomics standards of the sitting neck height for 5th percentile women and 95th percentile men. The device was checked for a range between 22 to 29 inches with the use of a standard measuring tape. A strength test was performed as well to further validate the FEA analysis. The device was mounted by straps and weight was added to the connector component until failure. The strength test was performed to provide further insight on how durable the design was.

Testing concluded with putting the device in use with actual salon customers and professional stylists. Two surveys were developed to allow the team to receive honest feedback on the device. The first survey was given to salon customers, and the second survey was given to the professional salon stylists. The device was rated on a scale from 1 to 5, with 1 being strongly disagree and 5 being strongly agree.

After the prototype was 3-D printed, the team conducted a series of tests outlined previously in this report at a local professional hair salon. First, the device was assembled on a Belvedere stationary hooded hair dryer and the fit and function of the device was assessed. The base of the device fit securely and evenly on the dryer with the straps attached. The device did not tip or appear unstable. Regarding the angle of the connector component, the bowl of the dryer did not have interference with the device, shown in FIG. 11.

The device was then checked to see if there was any interference with the user and if the device could reach the user at the appropriate neck position. FIG. 12 shows the device in use and contacting the upper part of the user's neck, as desired.

Next, the team conducted the heat test to validate the material selection. The device was assembled on the Belvedere dryer and the dryer's heat was turned on the maximum heat setting. As noted earlier, heat measurements were taken at various points on the device to ensure no critical temperatures were present.

At 5 minutes, the first set of temperature measurements were taken with an Infrared Temperature Scanner. Then, measurements were taken at 5-minute increments up until the 30-minute mark was reached. Table 1 below shows the results of the heat test.

Heat Test Results

| Time | Side of Base | Top of Connector | Cushion | Strap |
|---|---|---|---|---|
| (min) | (F) | (F) | (F) | Buckle (F) |
| 5 | 78.5 | 89.5 | 107 | 89.4 |
| 10 | 80.5 | 89.5 | 109 | 91.5 |
| 15 | 83.5 | 90.5 | 110.5 | 91.5 |
| 20 | 84 | 92.5 | 109 | 92.5 |
| 25 | 84 | 92 | 107 | 89 |
| 30 | 84 | 92 | 107 | 89.5 |

The results from Table 1 displays the highest temperature at 110.5 degrees Fahrenheit found at the cushion, which is directly under the heat source. However, the cushion material is Silicone and it is heat resistant up to 400 degrees Fahrenheit. ABS Plastic is heat resistant up to 264 degrees Fahrenheit, so the other temperatures are well below the critical limit for the device's material selection.

Following the heat test, the height validation test was conducted. With the device on the dryer, measurements were taken from the bottom of the chair to the center of the cushion, which measures the sitting height up to the neck. It was discovered that the dryer itself could not reach the 95th percentile men sitting height, yet the 5th percentile women sitting height was achieved. The height measurements are shown in Table 2 below, which validated the height requirement of the device.

TABLE 2
Sitting Neck Height Measurements
With Full Base

| | |
|---|---|
| 19.9375 | in |
| 21.0375 | in |
| 22.1375 | in |
| 24.3375 | in |

With Half Base Stacked

| | |
|---|---|
| 25.4375 | in |
| 26.5375 | in |

The last slot on the half base reaches the full range of the 5th percentile women. Originally, two full bases were printed, yet the dryer's neck would not extend upward enough for the 2nd full base slots to ever be utilized, so a half base was printed instead.

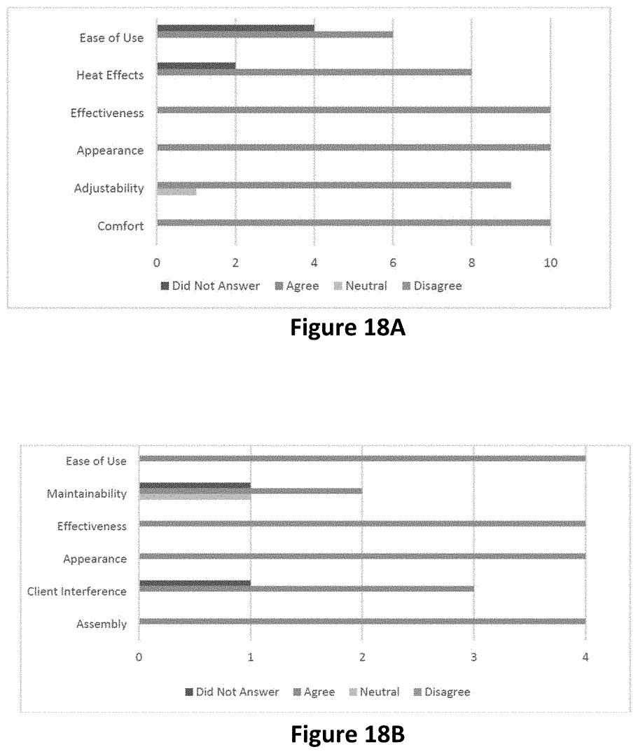

After the height validation test, the device was tested with actual salon users and professional salon stylists. The device was rated on comfort, adjustability, appearance, effectiveness, heat effects, and ease of use for the salon user survey. With 10 participants, the device received overall positive feedback, shown in FIG. 18.

From FIG. 18A, the device rated well on all the categories. A few of the salon customers did not answer on the ease of use category due to the stylist adjusting the device for them. The salon stylists rated the device on a few different categories such as client interference, maintainability, and assembly. With 4 participants, the stylists rated the device and the results were pleasing. FIG. 18B depicts the results.

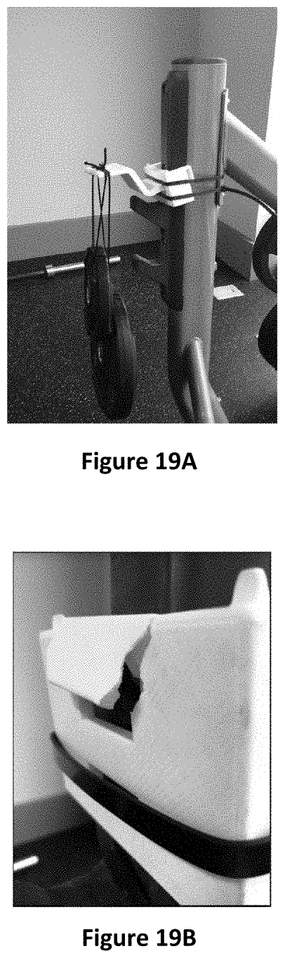

Lastly, to further validate the robust of the design, the strength test was done targeting the tab on the connector component. A spare half base and a spare connector part was assembled and constrained by straps, shown in FIG. 19A.

In FIG. 19A, the device is shown with weights that applied a downward force of 45 pounds on the top of the connector component. FIG. 19B displays the resulting reaction of the weight.

Once the weight limit reached 45 pounds, the base slot cracked and tore apart, instead of the anticipated weak point, the tab. Although the strength test displayed the base failing before the tab, the team still anticipates the tab to be the weakest point. Due to the prototype being 3-D printed, the device reacted differently to the weight. With injection molding, the device's strength will be enhanced as it is made as a whole and not made layer by layer, which is the method used in 3-D printing.

In an alternate embodiment, the neck rest fully integrated into a professional stationary salon dryer. Essentially, the product would replace the dryer's drying duct with an aftermarket one that has a neck rest built in. This type of product would eliminate the constraint issues for the neck rest and improve the build quality of the dryer itself.

References Used in This Example

Cohen, A. (2019, July). Beauty, Cosmetics & Fragrance Stores in the US. IBISWorld. Retrieved from https ://clients1.ibi sworld.com/reports/us/industry/ataglance.aspx?indid=1055.

Sally. (2017). Doing Business with Sally. Retrieved Oct. 2, 2018, from https://www. sallybeauty.com/on/demandware. store/Sites-SA-Site/default/Link-Page?cid=PAGE_DOING BUSINESS.

Trefis.com. (2017, August). Size of the global hair care market from 2012 to 2024 (in billion U.S. dollars)*. In Statista—The Statistics Portal. Retrieved Oct. 2, 2018, from https://www.statista.com/statistics/254608/global-hair-care-market-size/

### Example 2

Heads Up User Manual

NOTE: READ ALL INSTRUCTIONS BEFORE USE

What's Included: 1 base with straps; 1 half base with strap; 1 connector; 1 cushion support; 1 cushion; 2 screws

Tools Required: 1 Phillips-Head Screwdriver

Assembly

Step 1: Align the holes of the connector with that of the cushion support. Use a Phillips-Head screwdriver to insert the two screws into the components (see FIG. 2).

*The cushion support should be snug against the connector and should not wiggle.

Step 2: Place the cushion over the cushion support and connector as shown in FIG. 9.

Step 3: Place the base on the front portion of the dryer duct with the slots facing towards dryer bowl (see FIG. 6).

*Ensure that the base is all the way against the front of the dryer duct.

Step 4: Once the base is seated on the duct fasten the straps on back. Pull straps until device is snug against the dryer duct (see FIG. 8).

*Ensure that the device fits snuggly against the dryer duct before each use.

Step 5: If half base is needed for taller clients simply place the half base with the slots facing the dryer bowl on top of the other base (see FIG. 7). Be sure to align the small tabs on the taller base with holes on the bottom of the half base. Repeat Step 4.

Step 6: To complete assembly simply insert the connector into a slot that aligns with the client's neck (see FIG. 10). To adjust the height simply remove the connector and insert it into a new slot.

Care and Maintenance

Before each use:
a) Inspect the device for cracks and ensure straps are in good condition.
b) Check to make sure that all straps are connected and that the base is secured on the front of the dryer duct.
c) Ensure that the cushion is fitted properly on the cushion support.
d) If the half base is attached, check to make sure it is seated in the alignment holes on the other base and securely fastened.

After each use:
a) Wipe the device down with a damp cloth to ensure that there are no hair products left on the device.

Note: Never hang on the end of the connector; Never expose the device to temperatures greater than 180 F; If visible cracks are forming in the device discontinue use immediately.

### EQUIVALENTS

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Those skilled in the art will recognize, or be able to ascertain, using no more than routine experimentation, numerous equivalents to the specific substances and procedures described herein. Such equivalents are considered to be within the scope of this invention and are covered by the following sample representative claims.

1. A head support system configured for use with a commercially available professional stationary hair dryer for use in supporting a head of a user during drying of the user's hair, comprising:
a first base,
a connector, and
a support structure,
the first base having a back face and an opposing front face, the back face configured to removably and securely attach to said hair dryer, the front face having a plurality of support slots therein, the support slots spaced vertically from low-to-high to provide a plurality of support slot heights for use in adjusting a height of the support structure relative to the first base;
the support structure comprising a cushion configured to cushion the head of said user during use; and
the connector having a central portion, a rear portion, and a front portion,
the central portion having a rear side, an opposing front side, a lower end and an upper end,
the rear portion extending rearward from the rear side on or adjacent the lower end of the central portion and terminating in a rear end,
the front portion extending forward from the front side on or adjacent the upper end of the central portion and terminating in a front end such that the front end and the rear end are offset from one another,
the front end attached to the support structure,
the rear end having a locking tab thereon, the locking tab configured for selectively and removably securing the connector in the plurality of support slots of the first base for use in adjusting the height of the support structure.

2. (canceled)

3. The head support of claim 1, wherein the connector comprises an “S” shape.

4. The head support system of claim 1, the system further comprising a second base, the second base being stackable with the first base to increase a height of the support system.

5. The head support system of claim 1, wherein the system is configured to support the user's head without interfering with the user's hairstyle.

6. The head support system of claim 1, wherein the head support system is portable.

7. The head support system of claim 1, wherein the head support system weighs less than 20 pounds.

8. (canceled)

9. The head support system of claim 1, wherein the head support system is configured to support the heads of individuals with heights between a 5th percentile of females and a 95th percentile of males, inclusive.

10. The head support system of claim 8, wherein the head support system is configured to support the heads of individuals with heights between about 5 feet and about 6 feet, 6 inches.

11. The head support system of claim 1, wherein the head support system is configured to support at least 12 pounds.

12. The head support system of claim 1, wherein the head support system is resistant to deformation at high heat.

13. The head support system of claim 12, wherein the head support system is configured to provide support to a user in temperatures up to about 180° F.

14. The head support system of claim 1, wherein the head support comprises material that is resistant to deterioration by hydrogen peroxide, ammonia, aniline derivative, or a combination thereof.

15. The head support system of claim 1, wherein the head support system is configured to support itself so as not to place any downward force on said hair dryer.

16. (canceled)

17. The head support system of claim 1, wherein the head support system comprises ABS plastic, Silicone, or a combination thereof.

18. The head support system of claim 1, wherein the connector comprises two triangular faces.

19. (canceled)

20. The head support system of claim 1, wherein the first base, the connector, and the structure are aluminum.
